(19) United States
(12) Patent Application Publication
(10) Pub. No.: US 2021/0248339 A1
(43) Pub. Date: Aug. 12, 2021

(54) ULTRASONIC FINGERPRINT SENSING ARCHITECTURE

(71) Applicant: Egis Technology Inc., Taipei (TW)

(72) Inventors: Di Bao Wang, Taipei (TW); Chen-Chih Fan, Taipei (TW)

(73) Assignee: Egis Technology Inc., Taipei (TW)

(21) Appl. No.: 17/003,986

(22) Filed: Aug. 26, 2020

Related U.S. Application Data
(60) Provisional application No. 62/972,618, filed on Feb. 10, 2020.

(30) Foreign Application Priority Data
Jul. 27, 2020 (CN) 202010732227.0

(51) Int. Cl. G06K 9/00; B06B 3/00

(52) U.S. Cl. CPC G06K 9/0002; B06B 3/00

(57) ABSTRACT

An ultrasonic fingerprint sensing architecture is provided. The ultrasonic fingerprint sensing architecture includes a substrate, a plurality of ultrasonic transceivers, and a waveguide layer. The plurality of ultrasonic transceivers are disposed on the substrate. The waveguide layer is formed on the substrate. The waveguide layer includes a plurality of waveguides. The inside of the plurality of waveguides is filled with a first material and the outside of the plurality of waveguides is filled with a second material. An acoustic impedance of the first material is greater than an acoustic impedance of the second material. The plurality of waveguides are configured to align with the corresponded ultrasonic transceivers respectively in an acoustic wave transmission direction.

### CROSS-REFERENCE TO RELATED APPLICATION

This application claims the priority benefits of U.S. provisional application Ser. No. 62/972,618, filed on Feb. 10, 2020, and China application serial no. 202010732227.0, filed on Jul. 27, 2020. The entirety of each of the above-mentioned patent applications is hereby incorporated by reference herein and made a part of this specification.

### BACKGROUND OF THE INVENTION

### 1. Field of the Invention

The invention relates to a sensing architecture, and in particular, to an ultrasonic fingerprint sensing architecture.

### 2. Description of Related Art

A general ultrasonic sensing architecture usually transmits and receives an ultrasonic wave through a plurality of ultrasonic transceivers for fingerprint sensing. However, in the process of transmitting the ultrasonic wave by the plurality of ultrasonic transceivers, due to divergence of a spherical wave, the quality of ultrasonic echo signals received by the plurality of ultrasonic transceivers is likely to be poor, further causing poor contrast of a fingerprint image.

### SUMMARY OF THE INVENTION

In view of this, the invention provides an ultrasonic fingerprint sensing architecture, which may provide good ultrasonic sensing quality.

The ultrasonic fingerprint sensing architecture of the invention includes a substrate, a plurality of ultrasonic transceivers and a waveguide layer. The plurality of ultrasonic transceivers are disposed on the substrate. The waveguide layer is formed on the substrate. The waveguide layer includes a plurality of waveguides. The plurality of waveguides are internally filled with a first material and the outside of the plurality of waveguides is filled with a second material. An acoustic impedance of the first material is greater than an acoustic impedance of the second material. The plurality of waveguides are configured to align with the corresponded ultrasonic transceivers respectively in an acoustic wave transmission direction.

Based on the above, the ultrasonic fingerprint sensing architecture of the invention may transmit an ultrasonic wave through a waveguide structure, so that the divergence of the ultrasonic wave transmitted by the ultrasonic transceiver is effectively suppressed.

To make the features and advantages of the invention clear and easy to understand, the following gives a detailed description of embodiments with reference to accompanying drawings.

### BRIEF DESCRIPTION OF THE DRAWINGS

FIG. 1 is a schematic diagram of an ultrasonic fingerprint sensing architecture according to a first embodiment of the invention.

FIG. 2 is a schematic diagram of an ultrasonic fingerprint sensing architecture according to a second embodiment of the invention.

FIG. 3 is a schematic diagram of an ultrasonic fingerprint sensing architecture according to a third embodiment of the invention.

FIG. 4 is a schematic diagram of an ultrasonic fingerprint sensing architecture according to a fourth embodiment of the invention.

FIG. 5 is a schematic diagram of an ultrasonic fingerprint sensing architecture according to a fifth embodiment of the invention.

FIG. 6 is a schematic diagram of an ultrasonic fingerprint sensing architecture according to a sixth embodiment of the invention.

FIG. 7 is a schematic diagram of an ultrasonic fingerprint sensing architecture according to a seventh embodiment of the invention.

### DESCRIPTION OF THE EMBODIMENTS

To make the content of the invention more comprehensible, embodiments are described below as examples according to which the invention can indeed be implemented. Wherever possible, the same reference numbers are used in the drawings and the description to refer to the same or like parts, components or steps.

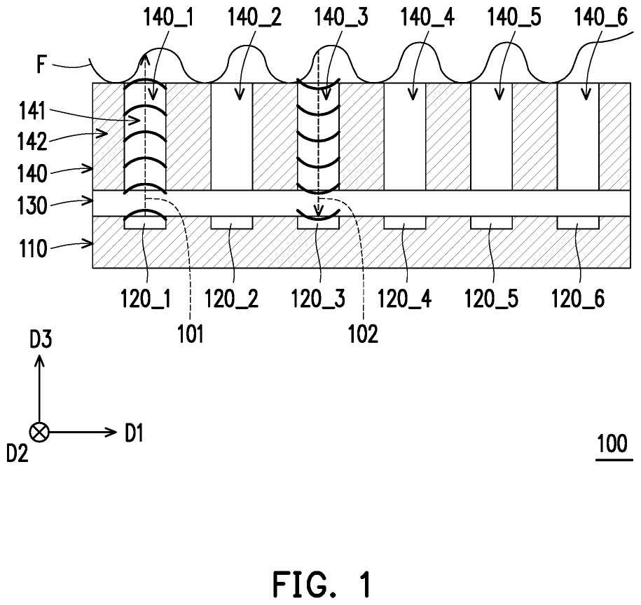

FIG. 1 is a schematic diagram of an ultrasonic fingerprint sensing architecture according to a first embodiment of the invention. Referring to FIG. 1, the ultrasonic fingerprint sensing architecture 100 includes a substrate 110, a plurality of ultrasonic transceivers 120_1 to 120_6, an adhesive layer 130 and a waveguide layer 140. The substrate 110 is, for example, parallel to a plane extending in a direction D1 and a direction D2. Directions D1, D2 and D3 are perpendicular to each other. In the present embodiment, the ultrasonic transceivers 120_1 to 120_6 are disposed on the substrate 110. The adhesion layer 130 is formed on the substrate 110. The waveguide layer 140 is formed on the adhesion layer 130. In the present embodiment, the waveguide layer 140 includes a plurality of waveguides 140_1 to 140_6. The waveguides 140_1 to 140_6 are configured to align with the corresponded ultrasonic transceivers 120_1 to 120_6 in an acoustic wave transmission direction respectively. In the present embodiment, the waveguides 140_1 to 140_6 are internally filled with a first material 141 and the outside of the waveguides 140_1 to 140_6 is filled with a second material 142. In the present embodiment, an acoustic impedance of the first material 141 is greater than an acoustic impedance of the second material 142, so that ultrasonic waves 101 emitted by the ultrasonic transceivers 120_1 to 120_6 may be effectively transmitted to a surface of a fingerprint F through the waveguides 140_1 to 140_6, and reflected acoustic waves 102 reflected by the surface of the fingerprint F may also be effectively transmitted to the ultrasonic transceivers 120_1 to 120_6 through the waveguides 140_1 to 140_6. The ultrasonic wave 101 and the reflected acoustic waves 102 shown in FIG. 1 are only for describing a transmission direction of an acoustic wave, and the number of acoustic waves in the invention is not limited thereto. In addition, a thickness of the adhesive layer 130 may be much less than thicknesses of other structural layers.

In the present embodiment, an acoustic impedance of the adhesive layer 130 may be close to the acoustic impedance of the first material 141 and greater than the acoustic impedance of the second material 142. The first material 141 may be, for example, a material such as a metal material, silicon nitride (SiN), silicon carbide (Silicon), or the like with a high acoustic impedance. The second material 142 may be, for example, an isolation polymer material or other materials with a low acoustic impedance.

In the present embodiment, the adhesive layer 130 and the waveguide layer 140 are sequentially formed on the substrate 110. The waveguide layer 140 may be fabricated in advance, so that the waveguides 140_1 to 140_6 of the waveguide layer 140 are aligned with the ultrasonic transceivers 120_1 to 120_6 on the substrate 110 in the acoustic wave transmission direction (that is, the direction D3) to be disposed on the substrate 110. In addition, the number of ultrasonic transceivers and the number of waveguides of the ultrasonic fingerprint sensing architecture 100 of the invention are not limited to that shown in FIG. 1. The substrate 110 of the ultrasonic fingerprint sensing architecture 100 of the invention may include a plurality of ultrasonic transceivers extending and arranged in the directions D1 and D2 to form an ultrasonic transceiver array, and the waveguide layer 140 may include a plurality of waveguides extending and arranged in the directions D1 and D2 to form a waveguide array.

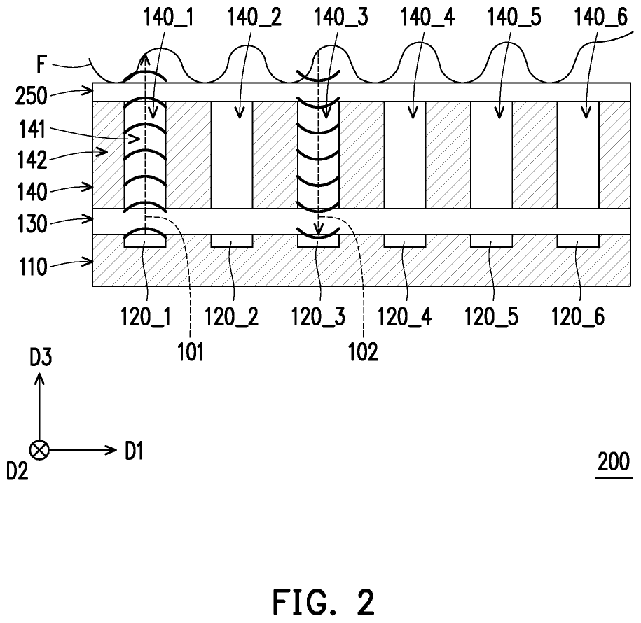

FIG. 2 is a schematic diagram of an ultrasonic fingerprint sensing architecture according to a second embodiment of the invention. Referring to FIG. 2, in comparison to FIG. 1, the ultrasonic fingerprint sensing architecture 200 of the present embodiment may further include a protective layer (scratch-resistant layer) 250. The protective layer 250 is formed on a waveguide layer 140. In the present embodiment, an acoustic impedance of the protective layer 250 may be close to an acoustic impedance of a first material 141 and greater than an acoustic impedance of a second material 142. A material of the protective layer 250 may be, for example, a material such as a metal material, silicon nitride (SiN), silicon carbide (Silicon), or the like with a high acoustic impedance. The materials of the first material 141 and the protective layer 250 are different, and the protective layer 250 is a non-transparent material, but the invention is not limited thereto. In an embodiment, the protective layer 250 may be a glass panel made of a transparent material. In the present embodiment, the adhesive layer 130 and the waveguide layer 140 are sequentially formed on a substrate 110, and the protective layer 250 is directly formed or installed on the waveguide layer 140.

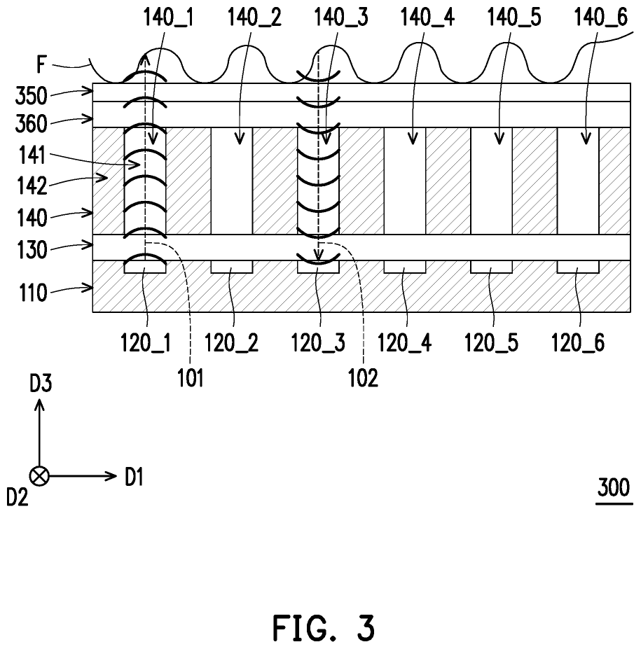

FIG. 3 is a schematic diagram of an ultrasonic fingerprint sensing architecture according to a third embodiment of the invention. Referring to FIG. 3, in comparison to FIG. 1, the ultrasonic fingerprint sensing architecture 300 of the present embodiment may further include an adhesive layer 360 and a protective layer (scratch-resistant layer) 350. In the present embodiment, an acoustic impedance of the adhesive layer 360 may be close to an acoustic impedance of a first material 141 and greater than an acoustic impedance of a second material 142. The adhesive layers 130 and 360 may be made of a same adhesive material or different adhesive materials. In the present embodiment, the materials of the first material 141 and the protective layer 350 are different, and the protective layer 350 is a non-transparent material, but the invention is not limited thereto. In an embodiment, the protective layer 350 may be a glass panel made of a transparent material. However, for structure features and material features of other structural layers in the present embodiment, reference may be made to the descriptions of the foregoing embodiments. In the present embodiment, the adhesive layer 130, the waveguide layer 140 and the adhesive layer 360 are sequentially formed on a substrate 110, and the protective layer 350 is installed on the waveguide layer 140 through the adhesive layer 360.

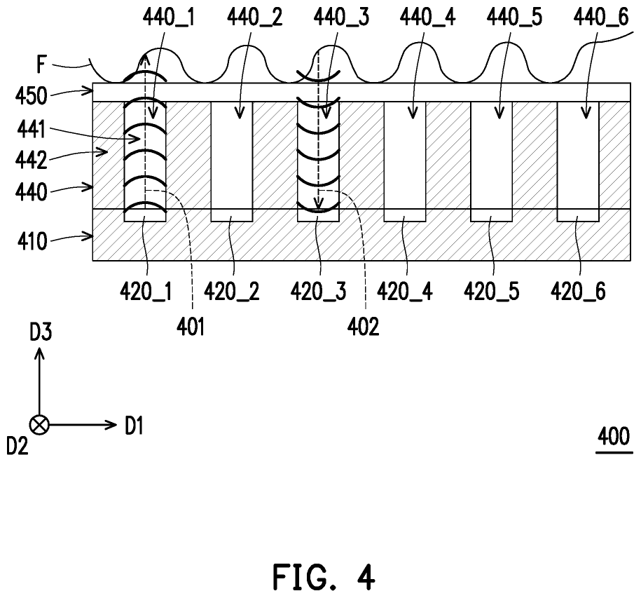

FIG. 4 is a schematic diagram of an ultrasonic fingerprint sensing architecture according to a fourth embodiment of the invention. Referring to FIG. 4, the ultrasonic fingerprint sensing architecture 400 includes a substrate 410, a plurality of ultrasonic transceivers 420_1 to 420_6, a waveguide layer 440 and a protective layer (scratch-resistant layer) 450. The substrate 410 is, for example, parallel to a plane extending in a direction D1 and a direction D2. In the present embodiment, the ultrasonic transceivers 420_1 to 420_6 are disposed on the substrate 410. The waveguide layer 440 is directly formed on the substrate 410, and the protective layer 450 is formed on the waveguide layer 440. In the present embodiment, the waveguide layer 440 includes a plurality of waveguides 440_1 to 440_6. The waveguides 440_1 to 440_6 are configured to align with the corresponded ultrasonic transceivers 420_1 to 420_6 respectively in an acoustic wave transmission direction.

In the present embodiment, the waveguides 440_1 to 440_6 are internally filled with a first material 441 and the outside of the waveguides 440_1 to 440_6 is filed with a second material 442. In the present embodiment, an acoustic impedance of the first material 441 is greater than an acoustic impedance of the second material 442, so that ultrasonic waves 401 emitted by the ultrasonic transceivers 420_1 to 420_6 may be effectively transmitted to a surface of a fingerprint F through the waveguides 440_1 to 440_6, and reflected acoustic waves 402 reflected by the surface of the fingerprint F may also be effectively transmitted to the ultrasonic transceivers 420_1 to 420_6 through the waveguides 440_1 to 440_6. However, for structure features and material features of other structural layers in the present embodiment, reference may be made to the descriptions of the foregoing embodiments.

In the present embodiment, the waveguide layer 440 and the protective layer 450 may be sequentially formed or installed on the substrate 410. The waveguide layer 440 may be fabricated in advance to be directly formed or disposed on the substrate 410. However, in an embodiment, in the process of manufacturing a semiconductor of the ultrasonic transceivers 420_1 to 420_6 on the substrate 410, a part of the first material 441 of the waveguide layer 440 may be further first formed on the substrate 410 through deposition, etching, or the like, and the waveguide layer 440 is aligned with the ultrasonic transceivers 420_1 to 420_6 on the substrate 410 in the acoustic wave transmission direction (that is, a direction D3). Next, a region other than the first material 441 of the waveguide layer 440 is filled with the second material 442. Finally, the protective layer 450 is directly formed or installed on the waveguide layer 440.

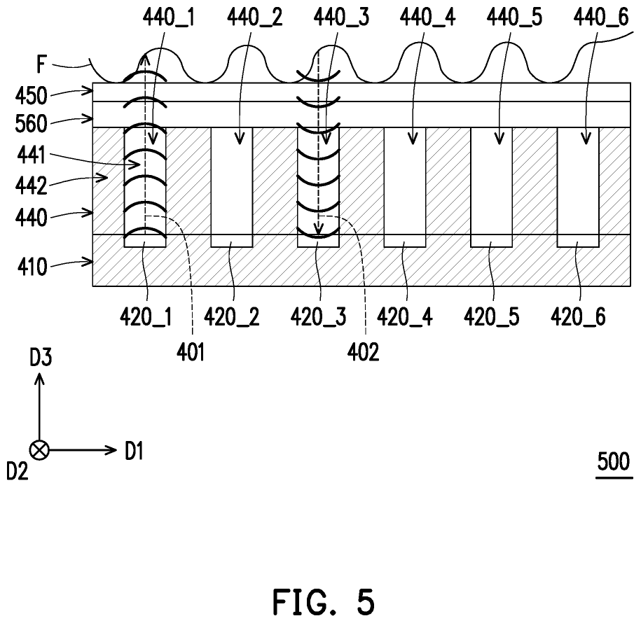

FIG. 5 is a schematic diagram of an ultrasonic fingerprint sensing architecture according to a fifth embodiment of the invention. Referring to FIG. 5, in comparison to FIG. 4, the ultrasonic fingerprint sensing architecture 500 of the present embodiment may further include an adhesive layer 560. The waveguide layer 440 is directly formed on the substrate 410, and the adhesive layer 560 is formed on the waveguide layer 440. The protective layer 450 is formed on the adhesive layer 560. In the present embodiment, the waveguide layer 440, the adhesive layer 560, and the protective layer 450 may be sequentially formed or installed on the substrate 410.

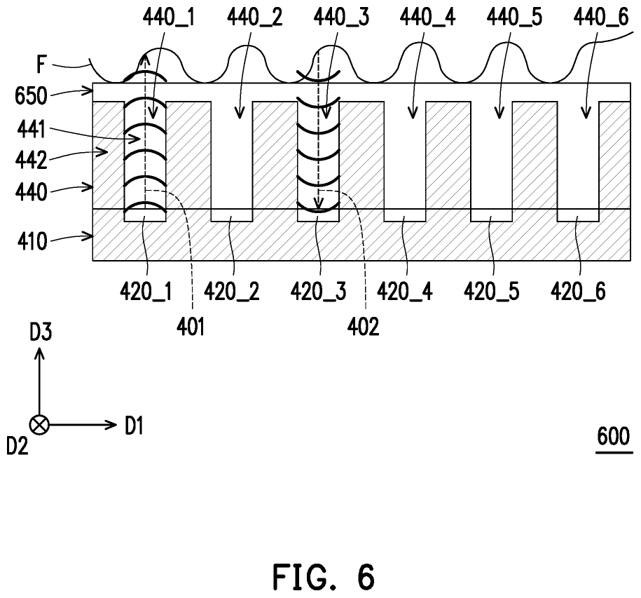

FIG. 6 is a schematic diagram of an ultrasonic fingerprint sensing architecture according to a sixth embodiment of the invention. Referring to FIG. 6, in comparison to FIG. 4, a protective layer (scratch-resistant layer) 650 and the waveguide layer 440 of the ultrasonic fingerprint sensing architecture 600 of the present embodiment may be formed or installed on the substrate 410 through a same manufacturing process. The protective layer 650 and the first material 441 of the waveguide layer 440 may be a same material. Different from the structure formation method of the embodiment in FIG. 4, in the present embodiment, in the process of manufacturing a semiconductor of ultrasonic transceivers 420_1 to 420_6 on the substrate 410, a part of a second material 442 of the waveguide layer 440 may be further first formed on the substrate 410 through deposition, etching, or the like, and a plurality of slots of a part of the second material 442 of the waveguide layer 440 are aligned with the ultrasonic transceivers 420_1 to 420_6 on the substrate 410 in an acoustic wave transmission direction (that is, a direction D3). Then, a part of the first material 441 of the waveguide layer 440 may fill the plurality of slots through deposition, and a protective layer 650 on the waveguide layer 440 is continuously formed. Therefore, the protective layer 650 and the part of the first material 441 of the waveguide layer 440 are integrally formed.

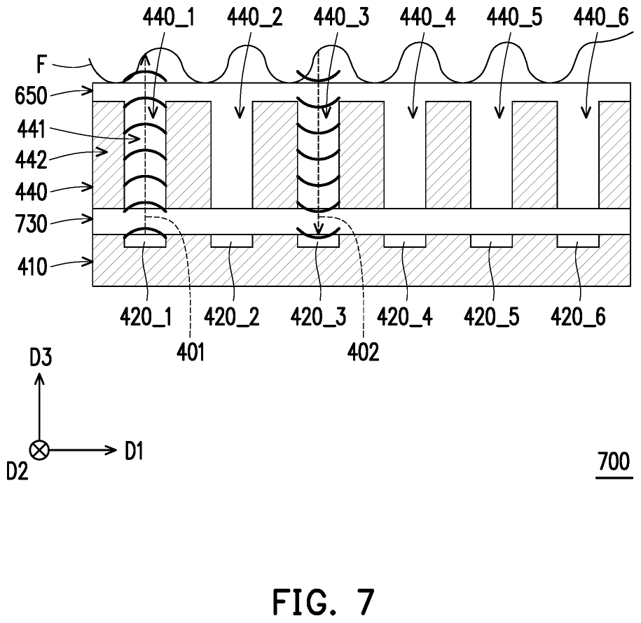

FIG. 7 is a schematic diagram of an ultrasonic fingerprint sensing architecture according to a seventh embodiment of the invention. Referring to FIG. 7, in comparison to FIG. 6, the ultrasonic fingerprint sensing architecture 700 of the present embodiment may further include an adhesive layer 730. In the present embodiment, the adhesive layer 730 is first formed on the substrate 410, then preformed modules of the waveguide layer 440 and the protective layer 650 are disposed on the substrate 410 through the adhesive layer 730, or the waveguide layer 440 and the protective layer 650 are sequentially formed on the substrate 410 by using the structure formation method in FIG. 6.

Based on the above, the ultrasonic fingerprint sensing architecture of the invention may provide an ultrasonic wave transmission effect with high directivity through a waveguide structure, so that the divergence of the ultrasonic wave transmitted by the ultrasonic transceiver is effectively suppressed. Therefore, the ultrasonic fingerprint sensing architecture of the invention may provide a fingerprint sensing effect with good echo signal quality and good fingerprint image contrast.

Although the invention is described with reference to the above embodiments, the embodiments are not intended to limit the invention. A person of ordinary skill in the art may make variations and modifications without departing from the spirit and scope of the invention. Therefore, the protection scope of the invention should be subject to the appended claims.

What is claimed is:

1. An ultrasonic fingerprint sensing architecture, comprising:
a substrate;
a plurality of ultrasonic transceivers, disposed on the substrate; and
a waveguide layer, formed on the substrate and comprising a plurality of waveguides, wherein the plurality of waveguides are internally filled with a first material and an outside of the waveguides is filled with a second material, wherein an acoustic impedance of the first material is greater than an acoustic impedance of the second material,
wherein the plurality of waveguides are configured to align with the corresponded ultrasonic transceivers respectively in an acoustic wave transmission direction.

2. The ultrasonic fingerprint sensing architecture according to claim 1, further comprising:
a first adhesive layer, formed between the waveguide layer and the substrate, wherein an acoustic impedance of the first adhesive layer is close to the acoustic impedance of the first material.

3. The ultrasonic fingerprint sensing architecture according to claim 2, further comprising:
a protective layer, formed above the waveguide layer, wherein an acoustic impedance of the protective layer is greater than the acoustic impedance of the second material.

4. The ultrasonic fingerprint sensing architecture according to claim 3, wherein the protective layer is a transparent material.

5. The ultrasonic fingerprint sensing architecture according to claim 3, wherein the protective layer is a non-transparent material.

6. The ultrasonic fingerprint sensing architecture according to claim 3, further comprising:
a second adhesive layer, formed between the waveguide layer and the protective layer, wherein an acoustic impedance of the second adhesive layer is greater than the acoustic impedance of the second material.

7. The ultrasonic fingerprint sensing architecture according to claim 1, further comprising:
a protective layer, formed above the waveguide layer, wherein an acoustic impedance of the protective layer is greater than the acoustic impedance of the second material.

8. The ultrasonic fingerprint sensing architecture according to claim 7, further comprising:
a second adhesive layer, formed between the waveguide layer and the protective layer, wherein an acoustic impedance of the second adhesive layer is greater than the acoustic impedance of the second material.

9. The ultrasonic fingerprint sensing architecture according to claim 7, wherein the protective layer is a transparent material.

10. The ultrasonic fingerprint sensing architecture according to claim 7, wherein the protective layer is a non-transparent material.

11. The ultrasonic fingerprint sensing architecture according to claim 7, wherein the protective layer and the first material are different materials.

12. The ultrasonic fingerprint sensing architecture according to claim 7, wherein the protective layer and the first material are a same material.

13. The ultrasonic fingerprint sensing architecture according to claim 12, further comprising:
a first adhesive layer, formed between the waveguide layer and the substrate, wherein an acoustic impedance of the first adhesive layer is greater than the acoustic impedance of the second material.
